(19) United States
(12) Patent Application Publication
(10) Pub. No.: US 2014/0189597 A1
(43) Pub. Date: Jul. 3, 2014

(54) METHOD AND ELECTRONIC DEVICE FOR PRESENTING ICONS

(71) Applicant: Samsung Electronics Co., Ltd., Gyeonggi-do (KR)

(72) Inventor: Myungsu KANG, Seoul (KR)

(73) Assignee: Samsung Electronics Co., Ltd., Gyeonggi-do (KR)

(21) Appl. No.: 14/140,850

(22) Filed: Dec. 26, 2013

(30) Foreign Application Priority Data
Dec. 28, 2012 (KR) 10-2012-0155947
Nov. 22, 2013 (KR) 10-2013-0142642

(51) Int. Cl. G06F 3/0481

(52) U.S. Cl. CPC G06F 3/04817
USPC 715/835

(57) ABSTRACT

According to one aspect of the disclosure, a method for presenting an icon is provided that includes displaying an icon for executing a function; displaying a notification associated with the icon; changing, by a processor, an attribute of the function from a first value to a second value based on an input received via the notification; and modifying the notification to indicate the second value of the attribute; wherein the notification is displayed and modified while the function is not executed by the processor.

### CROSS RELATED APPLICATION(S)

This application claims priority under 35 U.S.C. 119(a) to applications filed in the Korean Intellectual Property Office on Dec. 28, 2012 and Nov. 22, 2013, and assigned Serial Nos. 10-2012-0155947, 10-2013-0142642 respectively, the contents of which are incorporated herein by reference.

### TECHNICAL FIELD

The present disclosure relates to electronic devices in general, and more particularly to a method and electronic device for presenting icons.

### BACKGROUND

Portable electronic devices can provide a large variety of applications, such as voice/video call applications, messaging applications (e.g., SMS, MMS, or email clients), navigation applications, image capturing applications, electronic dictionaries, electronic organizers, media players, Internet browsers, and SNS (Social Networking Service) applications. As an interface for executing the applications, the portable devices may utilize a touch screen or another type of input device. The touch screen may display icons corresponding to different available applications and when input is received at one of the icons, the icon's corresponding application may be executed. In that regard, applications provided on portable devices can be executed by simply touching (or clicking on) icons corresponding to the applications.

While electronic devices permit applications to be accessed with ease, they may often require multiple steps to be performed in order to change configuration settings associated with the applications. For example, changing a sound volume associated with a specific application may require users to first trigger the application or adjust en bloc a setting value. However, requiring the users to perform multiple steps for changing configuration settings can be burdensome and inconvenient. Accordingly, the need exists for new techniques for changing configuration settings associated with functions that are provided by portable devices.

### SUMMARY

The present disclosure addresses this need. According to one aspect of the disclosure, a method for presenting an icon is provided that includes displaying an icon for executing a function; displaying a notification associated with the icon; changing, by a processor, an attribute of the function from a first value to a second value based on an input received via the notification; and modifying the notification to indicate the second value of the attribute; wherein the notification is displayed and modified while the function is not executed by the processor.

In accordance with another aspect of the disclosure, a method for presenting an icon is provided that includes displaying an icon for executing a function; displaying a first notification associated with the icon; in response to a first input to the first notification, displaying a second notification; and in response to a second input to the second notification, changing, by a processor, an attribute of the function from a first value to a second value; wherein the attribute of the function is changed while the function is not being executed by the processor.

In accordance with yet another aspect of the disclosure, an electronic device is provided comprising: a display panel configured to display an icon for executing a function and a notification associated with the icon; a touch panel configured to receive touch input; and a control unit configured to change an attribute of the function from a first value to a second value in response to a touch performed on the notification and modify the notification to indicate the second value of the attribute; wherein the notification is displayed and modified while the function is not being executed by the processor.

According to yet another aspect of the disclosure, an electronic device is provided comprising a processor configured to: display an icon for executing a function, the icon comprising a first portion and a second portion, the first portion including an image associated with the function and the second portion including a notification associated with an attribute of the function; change, by a processor, an attribute of the function from a first value to a second value based on an input received via the notification; and change an appearance of the icon, the changing of the appearance including modifying the notification to indicate the second value of the attribute; wherein the notification is displayed and modified prior to the function being executed by the processor.

### BRIEF DESCRIPTION OF THE DRAWINGS

FIG. 1 is a block diagram of an electronic device, in accordance with aspects of the disclosure.

FIG. 2 is a flowchart of a process for configuring a function through an icon for invoking the function, in accordance with aspects of the disclosure.

FIG. 3 is a flowchart of a process for applying information created by a function to an icon for executing the function, in accordance with aspects of the disclosure.

FIG. 4, FIG. 5 and FIG. 6 are diagrams illustrating processes for controlling a function through an icon for executing the function, in accordance with aspects of the disclosure.

FIG. 7 is a diagram depicting a plurality of icons arranged on a display screen, in accordance with aspects of the disclosure.

FIG. 8 is a diagram depicting icons linked to recently created contents, in accordance with aspects of the disclosure.

FIG. 9 is a diagram depicting an icon linked to a content list, in accordance with aspects of the disclosure.

FIG. 10 is a diagram depicting an icon linked to schedule information, in accordance with aspects of the disclosure.

FIG. 11 is a diagram depicting an icon linked to game information, in accordance with aspects of the disclosure.

FIG. 12 is a block diagram of an electronic device, in accordance with aspects of the disclosure.

### DETAILED DESCRIPTION

The following description with reference to the accompanying drawings is provided to assist in a comprehensive understanding of various aspects of the present disclosure as defined by the claims and their equivalents. It includes various specific details to assist in that understanding but these are to be regarded as merely exemplary. Accordingly, those of ordinary skill in the art will recognize that various changes and modifications of the examples described herein can be made without departing from the scope and spirit of the present disclosure. In addition, descriptions of well-known functions and constructions may be omitted for clarity and conciseness.

According to aspects of the disclosure, the terms “include” and “comprise,” as well as derivatives thereof, mean inclusion without limitation. Additionally, the term “or” means and/or, and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

According to aspects of the disclosure, the terms and words used in the following description and claims are not limited to the bibliographical meanings, but, are merely used by the inventor to enable a clear and consistent understanding of the present disclosure. Accordingly, it should be apparent to those skilled in the art that the following description of various aspects of the present disclosure is provided for illustrative purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “an icon” includes reference to one or more of such icons.

According to aspects of the disclosure, an electronic device may be any type of device that inherently or optionally uses a communication function. Specifically, an electronic device may include a mobile phone, a smart phone, a tablet PC, a video phone, an e-book reader, a desktop PC, a laptop PC, a netbook computer, a personal digital assistant (PDA), a portable multimedia player (PMP), an MP3 player, a mobile medical device, a digital camera, a digital broadcasting terminal, a portable game console, a wearable device (e.g., a head-mounted-device (HMD) such as electronic glasses, electronic clothes, an electronic bracelet, an electronic necklace, an electronic appcessory, an electronic tattoo, and a smartwatch), and any other equivalents. In some embodiments, an electronic device may be smart home appliance having a communication function, including, but not limited to, television, a digital video disk (DVD) player, audio equipment, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to aspects of the disclosure, an electronic device may include at least one of various medical devices (e.g., MRA (magnetic resonance angiography), MRI (magnetic resonance imaging), CT (computed tomography), and ultrasonograph), a navigation device, a GPS (global positioning system) receiver, an EDR (event data recorder), an FDR (flight data recorder), a vehicular infotainment device, a marine electronic device (e.g., a marine navigation system and a gyro compass), avionics, and an industrial or home robot.

According to aspects of the disclosure, an electronic device may include at least one of an electronic board, an electronic signature receiving device, a projector, furniture or a part of building/structure having a communication function, and various measuring instruments (e.g., a water meter, an electric meter, a gas meter, and a wave meter). An electronic device in this disclosure may be one or any combination of the foregoing various devices.

According to aspects of the disclosure, the term “icon” may refer to any visual representation, graphical item, or object for at least one of executing a function, adjusting the attribute of the function, and/or for representing information about content created during the execution of the function that is displayed before the function is invoked (e.g. executed). In other words, according to aspects of the present disclosure, the term “icon” may refer to any type of visual representation displayed on the screen of an electronic device that can be used to execute a particular function or subordinate menu linked thereto. It will be understood that the “icons” discussed throughout the disclosure may have various forms such as text, image, list, item, and combinations thereof.

In some implementations, any one of the icons discussed throughout the disclosure may be represented as a graphical object and may contain a changeable text, image, etc. therein. Additionally or alternatively, in some implementations, any one of the icons discussed throughout the disclosure may be represented as a pair of overlapped or neighboring graphical objects. Such icons may be selectively displayed on or hidden from the screen in response to any relevant input.

According to aspects of the disclosure, the term “function” may refer to one or more lines of processor-executable code which when executed by a processor of an electronic device cause the electronic device to provide a particular function (e.g., a telephony function, a dictionary function, etc.) to its user. By way of example, in some instances, the term “function” may refer to a software application. Additionally or alternatively, in some instances, the term “function” may refer to a portion of a software application.

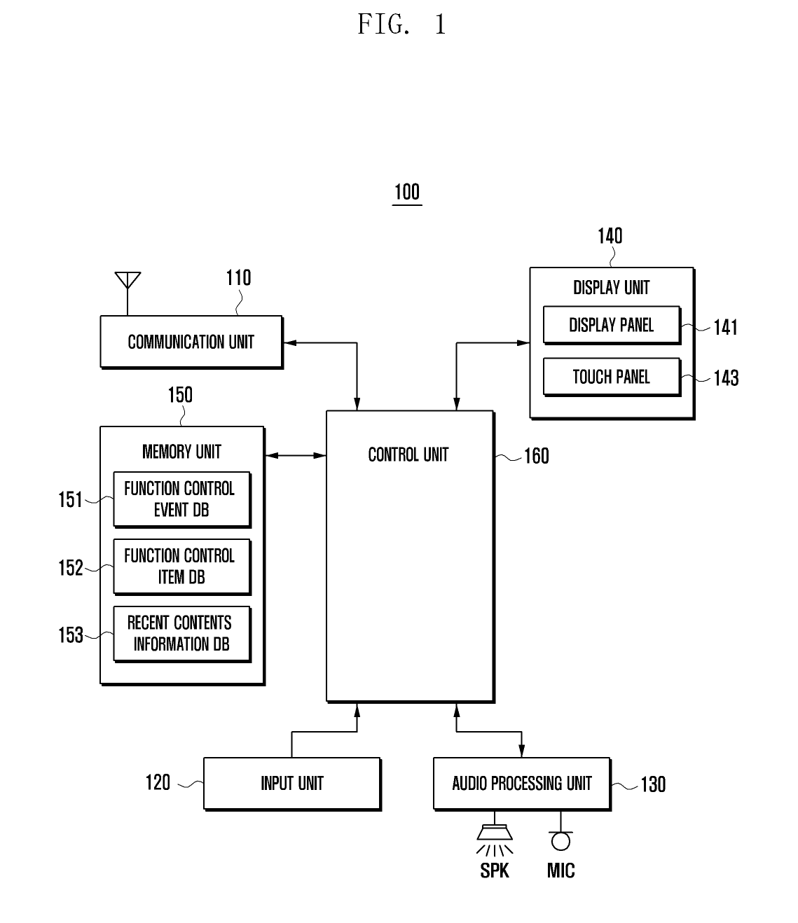

FIG. 1 is a block diagram of an electronic device in accordance with aspects of the disclosure. As illustrated, the electronic device 100 may include a communication unit 110, an input unit 120, an audio processing unit 130, a display unit 140, a memory unit 150, and a control unit 160.

The communication unit 110 may provide the electronic device 100 with communications capabilities. Namely, under the control of the control unit 160, the communication unit 110 may be operable to establish a communication channel with an available network (i.e., a base station) and transmit or receive signals associated with data communications such as voice calls, video calls, SMS (Short Message Service) messages, MMS (Multimedia Message Service) messages, and Internet access.

In some aspects, the communication unit 110 may convert voice/sound data and control data into wireless signals and then transmit the wireless signals. In addition, the communication unit 110 may also receive wireless signals and then convert the received signals into voice/sound data and control data. The communication unit 110 may include a transmitter that up-converts the frequency of an outgoing signal and then amplifies the signal. In addition, the communication unit 110 may include and a receiver that performs a low-noise amplification on an incoming signal and down-converts the frequency of the signal. Although in this example the communication unit 110 is depicted as a single integrated device, in other examples the communication unit 110 may include multiple devices corresponding to multiple communication schemes.

The input unit 120 may include one or more devices for receiving user input, such as a physical button, a trackball, a joystick, a touchpad, a keyboard, and/or any other suitable input device. In some aspects, the input unit 120 may be capable of recognizing a touch or approach of a user's finger or stylus. Additionally or alternatively, the input unit 120 may include a key, such as a dome key. When a user presses the dome key, the dome key is deformed and a corresponding input signal is created in a printed circuit board. In operation, the input unit 120 may create an input event in response to a user's input action and provide the control unit 160 with a signal indicating the event.

The audio processing unit 130 may include a speaker SPK for outputting audible sounds and a microphone MIC for receiving sound input, such as a user's voice or any other external sounds. The audio processing unit 130 may convert analog audio signals received from the microphone MIC into digital audio signals and then feed the converted signals to the control unit 160. In addition, the audio processing unit 130 may also convert digital audio signals received from the control unit 160 into analog audio signals and then feed the analog audio signals to the speaker SPK.

Additionally, the audio processing unit 130 may reproduce various audio signals generated in the electronic device 100 (e.g., music sounds during the playback of a music file). Particularly, the audio processing unit 130 may output audio signals associated with respective functions of the electronic device 100, such as a media playback function, a phone ringtone playback function, a notification ringtone playback function, an audible touch tone playback function, an alarm function, a screen lock or unlock function, a system booting function, a power off function, and the like. In some instances, audio signals of one function may be outputted in accordance with a specific volume attribute of the function that is different from respective volume attributes of other functions. Furthermore in some instances, the output of audio signals may be muted or replaced with vibration.

The display unit 140 may include a touch panel 143 and a display panel 141. The touch panel 143 may be operable to create an event in response to a touch-based user input and then output the event to the control unit 160. The display panel 141 may display data created as a result of the execution of a particular function.

In some aspects, the display unit 140 may display information about an attribute of the particular function. In some implementations, the attribute information may be displayed as part of an icon associated with the particular function. Alternatively, in some implementations, the attribute information may be displayed together with the icon associated with the particular function. Similarly, the display unit 140 may display an indication of content created as a result of the function being executed. In some implementations, the indication of content may be displayed as part of an icon associated with the function. Alternatively, in some implementations, the indication of content may be displayed together with the icon associated with the function.

In some aspects, the display unit 140 may display a function control item. In some implementations, the function control item may be displayed as part of an icon for invoking the function. Alternatively, in some implementations, the function control item may be displayed as being overlapped with or adjacent to the icon for invoking the function. The display unit 140 may display the function control item in order to independently adjust an attribute of the function. By way of example, the function may include a media playback function, a phone ringtone playback function, a notification ringtone playback function, an audible touch tone playback function, an alarm function, a screen lock or unlock function, a system booting function, a power off function, and the like. The attribute of the function may include volume level, and or any other suitable characteristic of the operation of the function. In some implementations, the display unit 140 may simultaneously display two or more function control items corresponding to respective attributes of a specific function. The simultaneously displayed function control items may be displayed adjacently, overlapped with, or displayed as part of the same icon.

In some aspects, the display unit 140 may remove a function control item from the screen when the distance between a touch pen and the function control item exceeds a threshold (e.g., 1 cm) or a touch input is not detected for a given time period. Herein, a touch pen refers to an electronic pen such as a stylus pen. The touch pen may have a specific button used for controlling a function of a touch-sensitive device.

The memory unit 150 may include any suitable type of volatile and/or non-volatile memory, such as a ROM (Read Only Memory), RAM (Random Access Memory), flash memory, and the like. The memory unit 150 may be embedded in the electronic device 100 and further have any external detachable storage such as a smart card. The memory unit 150 may be formed of individual components such as ROM, RAM and flash memory or formed of one or more integrated memories such as an MCP (Multi Chip Package) memory.

In some aspects, the memory unit 150 may store various data created and used by the electronic device 100. The data may include input information entered by a function control event, a function control item created in connection with a specific function of the electronic device 100, contents created during the execution of a specific function, data received from an external entity, a menu icon for triggering a specific function, a menu available in the electronic device 100, and/or any other suitable type of data.

In some aspects, the memory unit 150 may store any data required for or associated with the conduct of communications by the communication unit 110. In addition, in some aspects, the memory unit 150 may store various configuration settings associated with the operation of the electronic device 100. Also, the memory unit 150 may include one or more buffers for temporarily storing data created during the execution of a function. For example, such a buffer may store outgoing and incoming signals in connection with the communication unit 110.

In some aspects, the memory unit 150 may include function control event database 151, function control item database 152, and recent contents information database 153. The function control event database 151 may store a definition of a function control event. The function control event may be triggered by a touch or proximity of a touch pen or user's finger on or near an icon. The function control item database 152 may store a function control item corresponding to each of a plurality of icons. Specifically, the function control item database 152 may store a function control item defined to adjust an attribute (e.g., volume) of a function. In addition, the function control item database 152 may include an indication of a mapping between a function control item and an icon for invoking the control item's respective function. As noted above, the function control item may be used to change an attribute of the respective function. For example, the function control item may be operable to change a volume of the function, activate the function, deactivate the function, and or perform any other suitable action that is related to the execution of the function.

The recent contents information database 153 may store contents recently created by the execution of a function. In some aspects, the recently created content may be content created as a result of the last execution of the function (or N most recent executions of the function, wherein N is any integer). Additionally or alternatively, the recently created content may include content created during a predetermined time period (e.g., in the last 24 hours, in the last week, in the last 10 minutes.)

The contents, in some instances, may be arranged in the order in which they are created. For example, the recent contents information database 153 may store a recent photo file saved through a gallery application, a recent memo file created through a memo application, a recent call log made through a call application, a recent web address accessed through a web browser, information about a recent music file played through a music player, a recent alarm time set through an alarm application, information about a recent application purchased through a play store application, a current balance calculated through a housekeeping book application, a recent recording file recorded through a voice recorder application, information about a recent word searched through a dictionary application, information about a recent on/off state set through a Bluetooth application, information about a recent on/off state of a navigation application, a user's login status in a messenger application, and credit card details in a credit card application.

The control unit 160 may include any suitable type of processing circuitry, such as a processor (e.g., an ARM-based processor, an x86-based processor), a Field Programmable Gate Array (FPGA), or an Application Specific Integrated Circuitry (ASIC), for example. In operation, the control unit 160 may control the operation of the electronic device 100 and control signal flows between internal components of the electronic device 100. Namely, the control unit 160 may control signal flows among the communication unit 110, the input unit 120, the audio processing unit 130, the display unit 140 and the memory unit 150.

In some aspects, the control unit 160 may render an icon in an idle screen, a menu screen, a call screen, a function execution screen, or the like. Additionally, the control unit 160 may receive a user input selecting the icon and detect the occurrence of a function control event based on the received user input. Further, the control unit 160 may control the display unit 140 to display information associated with a changed attribute of a function in or together with the icon and also control the memory unit 150 to store information about the changed attribute of a function. In some implementations, the function control event may be detected, the function attribute changed, and a notification associated with the attribute modified, while the function is not being executed by the control unit 160.

Moreover, the control unit 160 may adjust an attribute of the function without displaying any input or output component, in addition to the icon. For example, the control unit 160 may detect an input to the icon having a predetermined characteristic and, in response, change an attribute of the function from a first value to a second value. The attribute of the function may specify any suitable characteristic of the function's operation. For example, the attribute of the function may specify a volume level, the kind of voice (e.g., man's voice or woman's voice) used to provide prompts when the function is executed, or the type of a sound source (e.g., a speaker or an earphone) used by the function to generate sound. The characteristic may include direction of a drag, a count of touches performed as part of the input, a duration of a touch, and/or any other suitable characteristic. In some implementations, the input having the predetermined characteristic may include an input of character, number, and symbol. Thus, by way of example, a user may change an attribute of the function by drawing (with a finger or stylus) a specific number, letter, or symbol, at least in part, on the icon for invoking the function.

In some aspects, the control unit 160 may perform a particular function on the basis of a changed attribute of that function. For example, the control unit 160 may control the audio processing unit 130 to output audio, based on the second value of the attribute when the function is executed.

In some aspects, the control unit 160 may determine whether any content is created during the execution of a function, and store information about the created content in the memory unit 150. The control unit 160 may control the display unit 140 to display such content in or together with an icon for invoking (e.g., executing) the function. In some aspects, displaying the content in the icon may include generating a new icon (e.g., an image file) based on the content and associating the new icon with the function. Furthermore, in some aspects, displaying the content in the icon may include generating a new icon based on both the content and another icon that is associated with the function.

Although not illustrated in FIG. 1, the electronic device 100 may further include any other suitable element, such as a camera module, a short-range communication module, an Internet access module, a digital broadcasting module, a GPS module, a vibration motor, and the like. As will be understood by those skilled in the art, some of the above-mentioned elements in the electronic device 100 may be omitted or replaced with another.

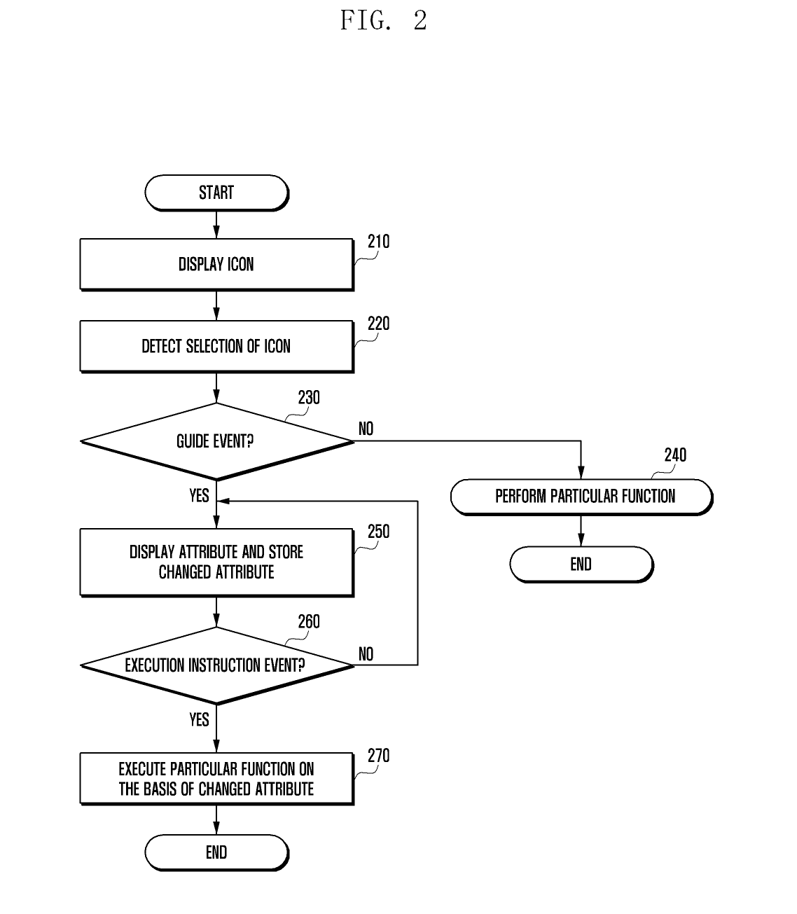

FIG. 2 is a flowchart of a process for configuring a function through an icon for invoking the function, in accordance with aspects of the disclosure. At operation 210, the control unit 160 may control the display unit 140 to display an icon for invoking (e.g., executing) a function. By way of example, and depending on the function, the icon may include a gallery icon, a memo icon, a call icon, a web browser icon, a music player icon, an alarm icon, a play store icon, a book icon, a voice recorder icon, a dictionary icon, and a Bluetooth icon. In that regard, the function may include a media playback function, a phone ringtone playback function, a notification ringtone playback function, an audible touch tone playback function, an alarm function, a screen lock or unlock function, a system booting function, a power off function, a picture viewing function, a telephony function, an Internet browsing function, a dictionary function, and/or any other suitable function.

At operation 220, the control unit 160 may detect a selection of the icon by a user input (e.g., detect that the icon is touched). At operation 230, the control unit 160 may determine whether to generate a guide event. In particular, the control unit 160 may generate the guide event only when the user input possesses a given characteristic. For example, if a hovering gesture is performed on the icon for longer than a first time period, the control unit 160 may generate the guide event. As yet another example, if a touch on the icon lasts longer than a second time period (which may be identical to the first time period), the control unit 160 may generate the guide event. Conversely, if a hovering on the icon is released within the first time period or if a touch on the icon is released within the second time period, the control unit 160 may decide not to generate the guide event. If a guide event is generated, the control unit 160 proceeds to execute operation 250. Otherwise, if the guide event is not generated, the control unit 160 may execute the function corresponding to the icon at operation 240.

At operation 250, the control unit 160 may control the display unit 140 to display a notification associated with the function (e.g., an indication of a value of an attribute (e.g., a volume) of a relevant application). The notification may be displayed adjacent to the icon or within the icon. Alternatively, a portion of the notification may be displayed as overlapping with the icon. Moreover, in some instances, the control unit 160 may control the display unit 140 to display a plurality of notifications. For example, such notifications may indicate a volume to which the function is set, state of the function (e.g., whether the function is in a deactivated state), or the like.

Additionally or alternatively, at operation 250, the control unit 160 may detect an attribute change event. The attribute change event may be detected when a predetermined user input is performed on the notification associated with the function. For example, an attribute change event may be detected when a drag is performed on “a volume adjust bar” that is part of the notification. In response to the attribute change event, the control unit 160 may change an attribute of the function and then store the new value of the attribute in the memory unit 150. Also, the control unit 160 may modify the notification to indicate the new value of the attribute. In some instances, if a touch on the notification is released or if a third time period elapses from the release of the touch, the control unit 160 may control the display unit 140 to remove the notification from display.

Next, at operation 260, the control unit 160 may determine whether an execution instruction event has occurred. For example, in case a user input (e.g., a tap) is detected on an icon, the control unit 160 may determine that an execution instruction event has occurred and proceed to operation 270. At operation 270 the function corresponding to the icon is executed based on the changed attribute.

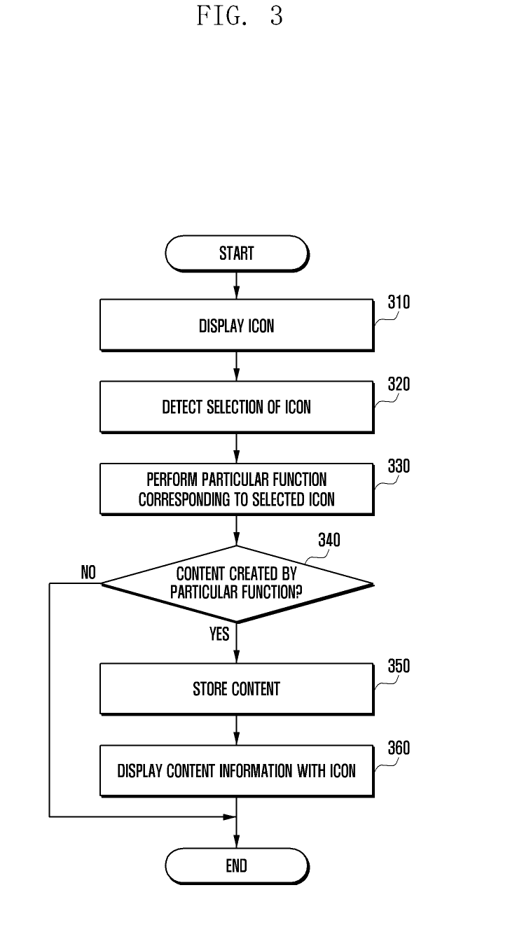

FIG. 3 is a flowchart of a process for applying information created by a function to an icon for executing the function, in accordance with aspects of the disclosure. At operation 310, the control unit 160 may control the display unit 140 to display an icon. At operation 320, the control unit 160 may detect a selection of the icon (e.g., a tap on an icon). At operation 330, the control unit 160 may execute a function corresponding to the selected icon. At operation 340, the control unit 160 may determine whether any content is created as a result of the execution of the function. For example, the control unit 160 may determine whether any content is created during the execution of a gallery application, a memo application, a call application, a web browser, a music player, an alarm application, a play store application, a housekeeping book application, a voice recorder application, a dictionary application, a Bluetooth application, or the like. If content is created, the process proceeds to step 350. Otherwise, the execution of the process ends.

At operation 350, the control unit 160 may store the created content in the memory unit 150. By way of example, the created content may include, a photo file created through a gallery application, a memo file created through a memo application, a call log (including a phone number of a caller or a recipient) created through a call application, a web access log (including a web address) created through a web browser, information (e.g., a music title, singer, etc.) about a music file played through a music player, an alarm time set through an alarm application, information (e.g., an application name) about an application purchased through a play store application, a current balance calculated through a housekeeping book application, information (e.g., a recording time, a file name, etc.) about a recording file recorded through a voice recorder application, information about a word searched through a dictionary application, information indicating the execution or not of a Bluetooth application, information as a result of the execution of a navigation application (e.g., a route between two user-specified points), a user's login status in a messenger application, and credit card details in a credit card application. Furthermore, in some implementations, the control unit 160 may store information about an attribute of such created content in the memory unit 150. For example, attribute information may include, but not limited to, creation time, type, number, title, and summary of content.

Next, at operation 360, the control unit 160 may apply content information (e.g., information about recently stored contents) to an icon. Namely, the control unit 160 may control the display unit 140 to display, in or together with an icon, information (e.g., a notification) about contents recently created at operation 350.

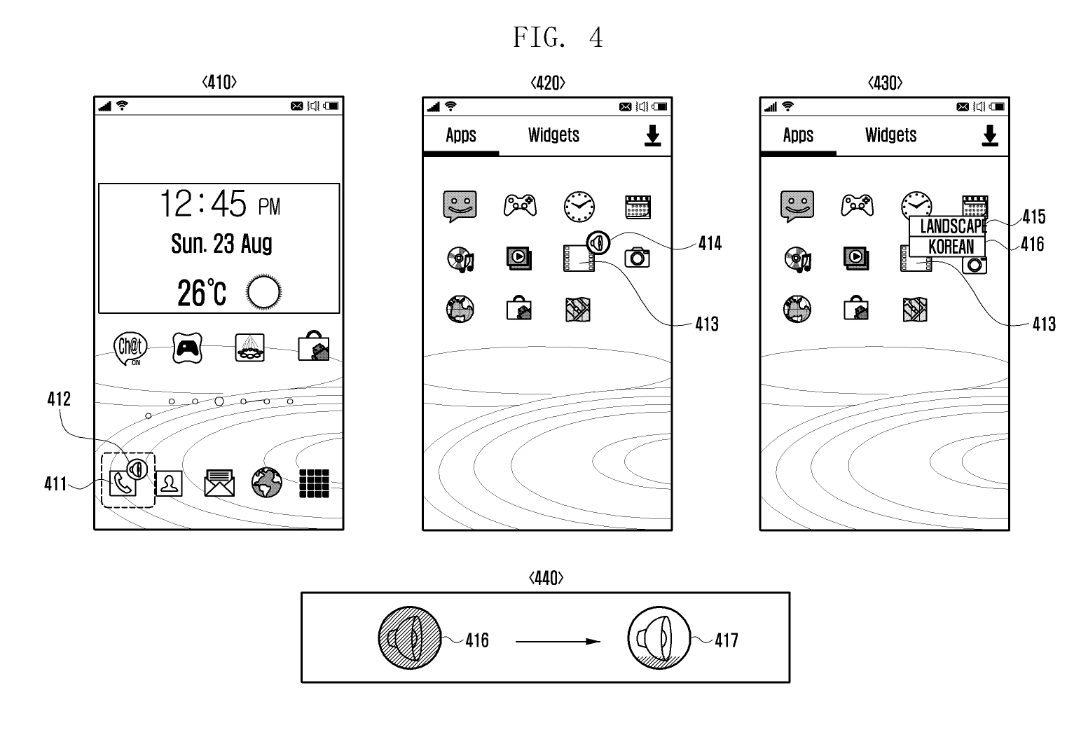

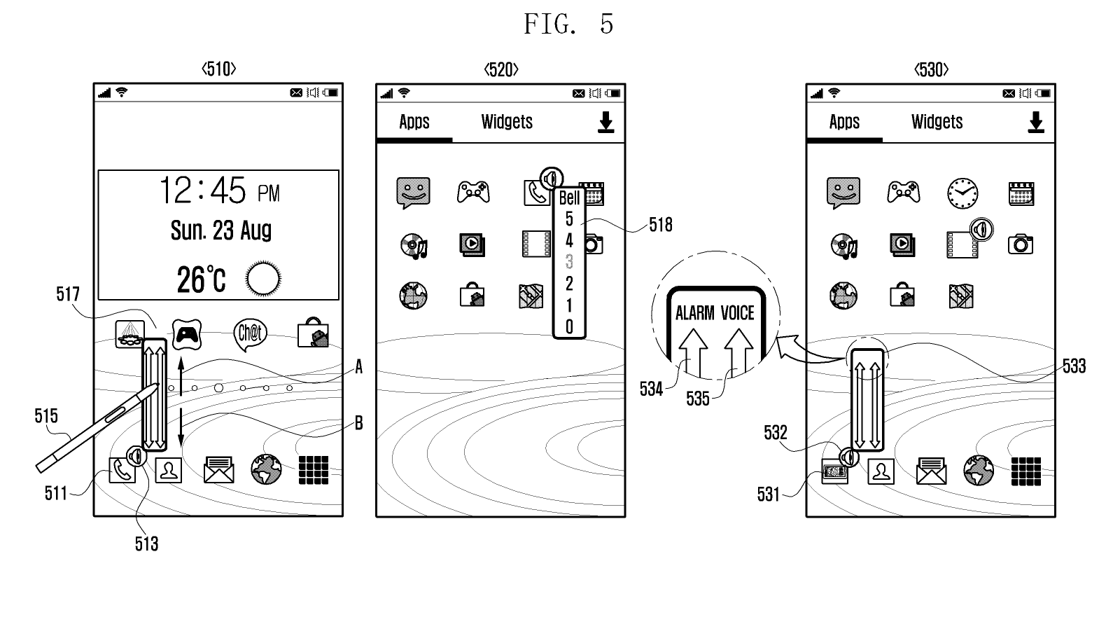

FIGS. 4 and 5 are diagrams illustrating processes for controlling a function through an icon for executing the function, in accordance with aspects of the disclosure. Referring to FIG. 4, the control unit 160 may control the display unit 140 to display an operation screen 410 that contains a call icon 411 or a notification 412 associated with a call volume of a call application. Further, the control unit 160 may control the display unit 140 to display operation screen 420, which may contain a media player icon 413 and a notification 414 associated with a playback volume of the media player (i.e., volume at which sounds produced by the media player especially are output). As illustrated, in this example, the notifications 412 and 414 include a speaker item (e.g., a visual representation of a speaker). It should be noted, however, that any notification associated with any other attribute of a function may be alternatively or additionally displayed. As illustrated, an operation screen 430 may be displayed that contains a media player icon 413, a notification 415 associated with a display mode in which the media player is to display media if executed (e.g., a landscape mode), and a notification 416 associated with a language in which the media player will display subtitles if executed (e.g., Korean).

In response to a guide event associated with the call icon 411, the control unit 160 may control the display unit 140 to display the speaker item 412. Additionally, in response to a guide event associated with the media player icon 413, the control unit 160 may control the display unit 140 to display the speaker item 414. In some implementations, any of the notifications 412 and 414 may be displayed as part of the icon 414. In such instances, the icons 411 and 414 may include an image associated with the icon's respective applications (e.g., an image of a telephone headset or an image of film segment) along with a visual representation of an attribute of the icon's respective applications (or functions). As can be appreciated, in the latter implementations, the notification 412 and 414 may not need a guide event to be detected in order for them to be displayed.

In response to an attribute change event associated the speaker item 412, the control unit 160 may change a call volume. Additionally, the control unit 160 may modify the speaker item 412 so as to indicate that the call volume is changed. As another example, in response to an attribute change event associated with the speaker item 412, a volume associated with the speaker item 414 may be adjusted. For instance, if a touch is performed on the speaker item 414 in an upward direction, the speaker item 414 may be represented with increasing shade, to indicate an increase in playback volume.

In some aspects, any suitable characteristic of an icon's notification may be modified based on a change in an attribute of the function associated with the icon. In some aspects, the modification may include adding a visual effect (e.g., shading) to the icon's notification. Additionally or alternatively, in some aspects, the modification may include changing a characteristic of the appearance of the icon's notification, such as size, shape, and color. For example, the screen 440, which is shown in FIG. 4, illustrates a variation of volume through light and shade represented in the speaker item. For example, a dark image of a speaker item 416 may indicate a higher volume, and a light image of the speaker item 417 may indicate a lower volume. In alternative implementations, the magnitude of the volume may be represented using at least one of shape, color and size of the speaker item instead of using light and shade. In still other alternative implementations, the magnitude of the volume may be represented using character, number or symbol associated with the speaker item. Therefore, a user can perceive intuitively a volume through a speaker item. Further, without many stepwise manipulations, a user can adjust a volume through a speaker item.

Referring to FIG. 5, an operation screen 510 may be displayed on the device 100 that contains a call icon 511, a first notification 513, and a second notification 517. The first notification 513 may be referred to as a speaker item, and the second notification 517 may be referred to as an arrow item. For example, when the speaker item 513 is selected by a user, the control unit 160 may control the display unit 140 to display the arrow item 517. If the direction of a user input (e.g., a drag of a touch pen 515) to the arrow item 517 is direction A, the volume of the device 100's ringer may be increased. In contrast, if the direction of the user input is direction B, the volume of the ringer may be decreased.

As another example, an operation screen 520 may be displayed on the device 100 that contains a third notification 518 which may be referred to as a numerical item. For example, this numerical item 518 may be a notification indicating the volume of a phone ringtone in proportion to a number. If a relatively greater number is selected in the numerical item 518, the volume of a phone ringtone may be increased. In contrast, if a relatively lower number is selected in the numerical item 518, the volume of a phone ringtone may be decreased.

As yet another example, an operation screen 530 may be displayed on the device 100 that contains a navigation icon 531, a first notification 532, and a second notification 533. The first notification 532 may be referred to as a speaker item. The second notification 533 may include an alarm sound indicator 534 and a guide voice indicator 535. If the speaker item 532 is selected by a user, the control unit 160 may control the display unit 140 to display both the alarm sound indicator 534 and the guide voice indicator 535. For example, a user can change a volume size of an alarm sound (e.g., an alert sound indicating that a user is travelling at an excessive speed) through the alarm sound indicator 534, and change a volume size of a guide voice through the guide voice indicator 535.

FIG. 6 is a diagram illustrating a process of controlling a function through an icon in accordance with aspects of the disclosure. Referring to FIG. 6, an operation screen 630 may be displayed on the device 100 that contains an alarm icon 632. The alarm icon 632 may be associated with an alarm function for sounding an alarm at a specified alarm time. As illustrated, the alarm icon 632 may include at least one notification for indicating the alarm time, e.g., an hour hand item 633 and a minute hand item 634. The control unit 160 may recognize the occurrence of an attribute change event in response to a user input that is performed on the alarm icon 632. For example, if a user rotates in the third direction (e.g., clockwise) the minute hand item 634 by using a touch pen 650, the alarm time may be changed based on the rotation. Also, the control unit 160 may control the display unit 140 to display a changed alarm time. For example, as shown in screens 630 and 640, the alarm time may be changed from 5:50 to 6:15.

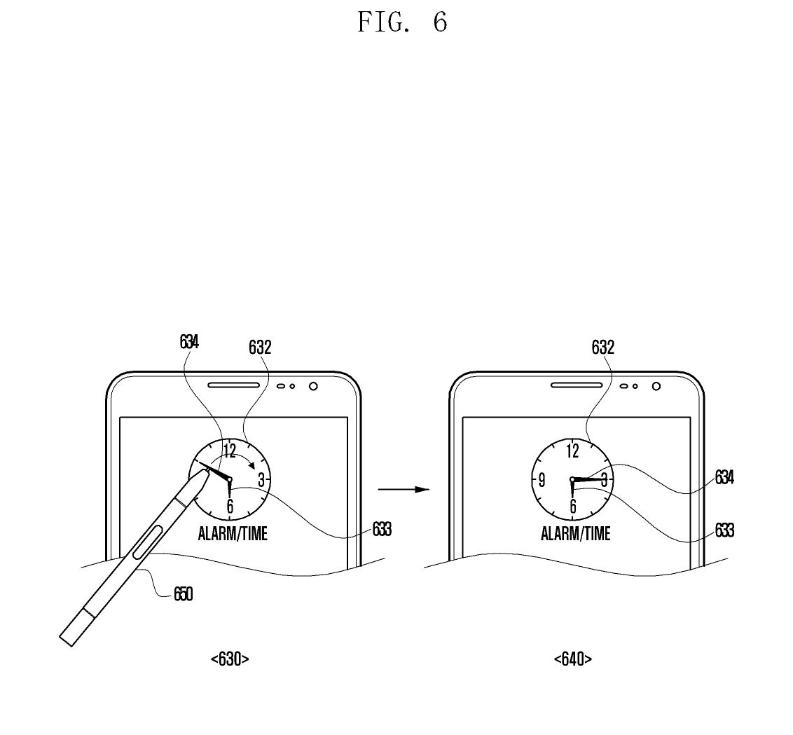

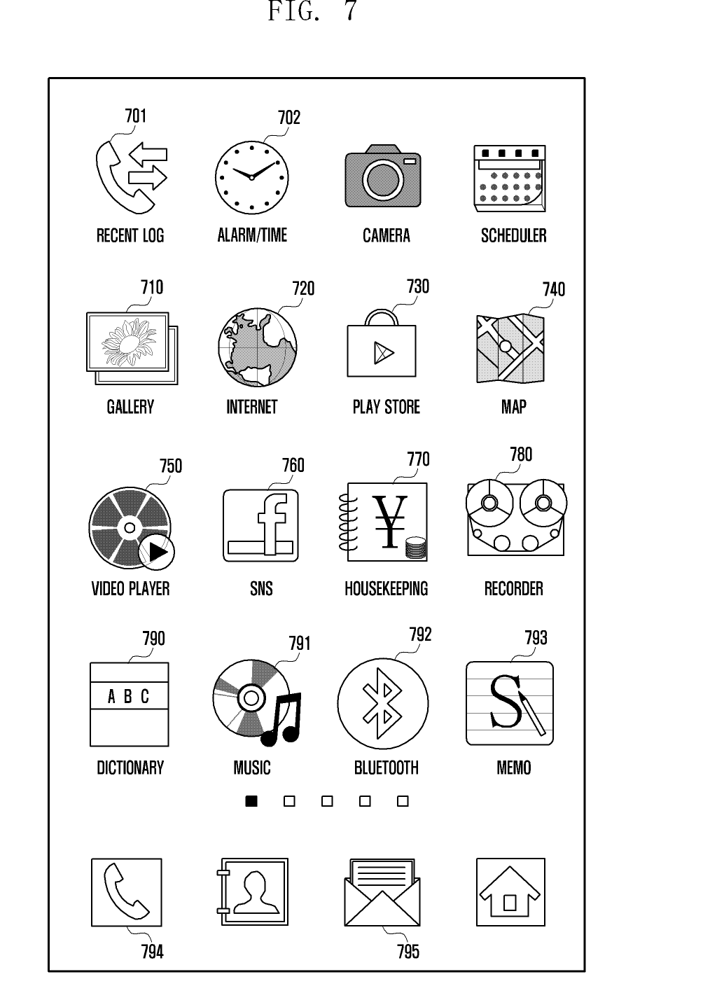

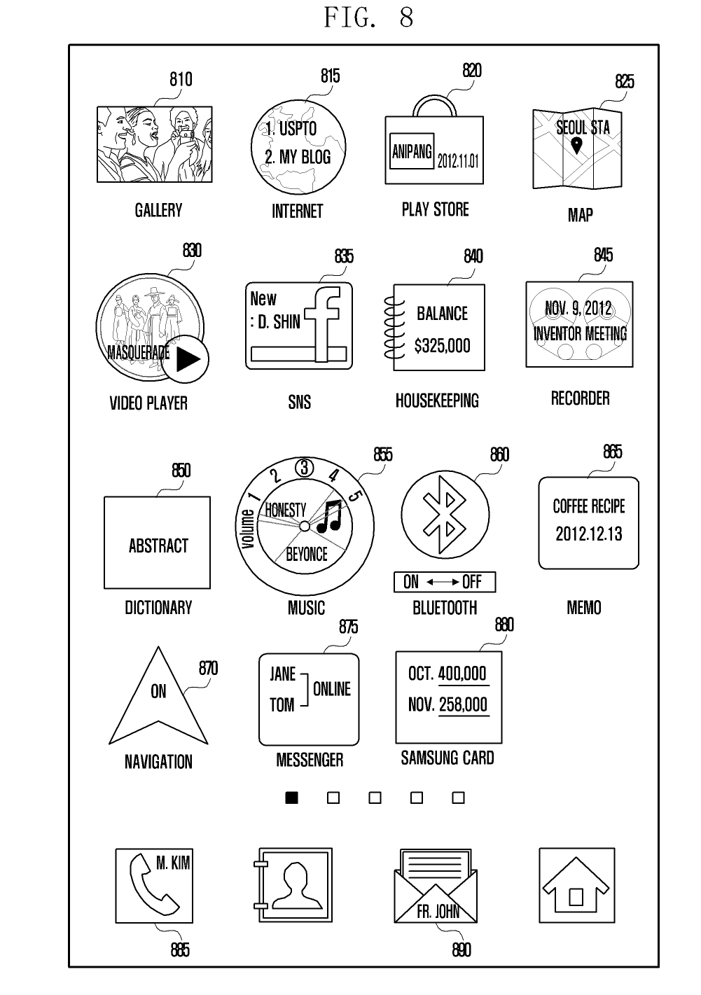

FIG. 7 is a diagram depicting a plurality of icons arranged on a display screen in accordance with aspects of the disclosure. Referring to FIG. 7, an operation screen (e.g., a home screen) may be displayed that contains a call record icon 701, an alarm icon 702, a gallery icon 710, a web browser icon 720, a play store icon 730, a map icon 740, a video player icon 750, a social network icon 760, a housekeeping book icon 770, a voice recorder icon 780, a dictionary icon 790, a music player icon 791, a Bluetooth icon 792, a memo icon 793, a call icon 794, and an email icon 795. Such icons arranged on the operation screen may be displayed as shown in FIG. 8, together with information about recent content which is created during the execution of a corresponding application.

FIG. 8 is a diagram depicting icons that have been linked to recently created contents, in accordance with aspects of the disclosure. In accordance with the example of FIG. 8, an operation screen (e.g., a home screen) may be displayed that contains various types of information (e.g., icons, content information, etc.) including, but not limited to, a gallery icon 810, a web browser icon 815, a play store icon 820, a map icon 825, a video player icon 830, a social network icon 835, a housekeeping book icon 840, a voice recorder icon 845, a dictionary icon 850, a music player icon 855, a Bluetooth icon 860, a memo icon 865, a navigation icon 870, a messenger icon 875, a credit card icon 880, a call icon 885, and an email icon 890.

Such icons show information about contents created recently during the execution of relevant application and applied thereto. For example, a recent photo file saved through a gallery application may be displayed in the gallery icon 810. Further, a recent web address accessed through a web browser may be displayed in the web browser icon 815. Further, information about a recent application (e.g., application name, purchase amount, originator, purchase date, etc.) purchased through a play store application may be displayed in the play store icon 820. Further, information about a recently searched location (e.g., Seoul station) may be displayed in the map icon 825. Further, information about a recently played video (e.g., Masquerade) may be displayed in the video player icon 830. Further, information about a recently contact member (e.g., D. Shin) may be displayed in the social network icon 835. Further, a current balance calculated through a housekeeping book application may be displayed in the housekeeping book icon 840. Further, information about a recent recording file recorded through a voice recorder application may be displayed in the voice recorder icon 845. Further, information about a recent word searched through a dictionary application may be displayed in the dictionary icon 850. Further, information about a recent music file (e.g., music title, songwriter, singer, part of lyrics, etc.) played through a music player may be displayed in the music player icon 855. Further, information about a recent on/off state set through a Bluetooth application may be displayed in the Bluetooth icon 860. Further, information about a recent memo file (e.g., at least one of theme, title, summary, partial content, creation date, and creator) created through a memo application may be displayed in the memo icon 865. Further, information about a recent on/off state of a navigation application may be displayed in the navigation icon 870. Further, information about a user's login status (e.g., online, busy, be right back, away, in a call, etc.) in a messenger application may be displayed in the messenger icon 875. Further, credit card details (e.g., statement balance, view credit limit, outstanding balance, etc.) in a credit card application may be displayed in the credit card icon 880. Further, a recent call log may be displayed in the call icon 885. Further, a recent mail log may be displayed in the email icon 890.

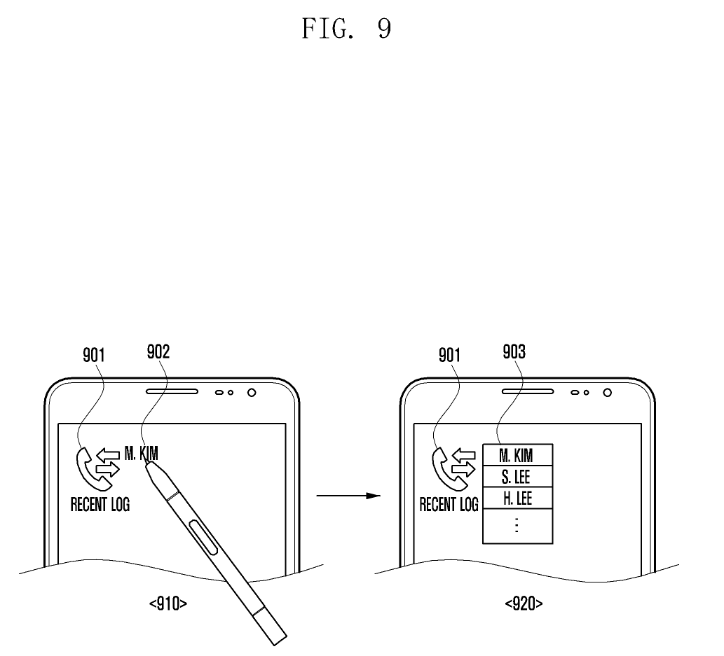

FIG. 9 is a diagram depicting an icon that has been linked to a content list, in accordance with aspects of the disclosure. Referring to FIG. 9, the control unit 160 may control the display unit 140 to display an operation screen 910 that includes a call log icon 901 and information notification 902. The information notification 902 indicates a characteristic (e.g., name) of a participant in a prior phone call. When the information notification 902 is selected by a user, the control unit 160 may control the display unit 140 to display a content list 903 (i.e., another type of notification) together with the call log icon 901 on the screen 920. The content list may identify characteristics of a plurality of participants in prior phone calls. In some aspects, the phone call characteristics in the list 903 may be sorted according to the times when the phone calls took place, in an alphabetical order, in a user-specified order, and/or any other suitable type of order.

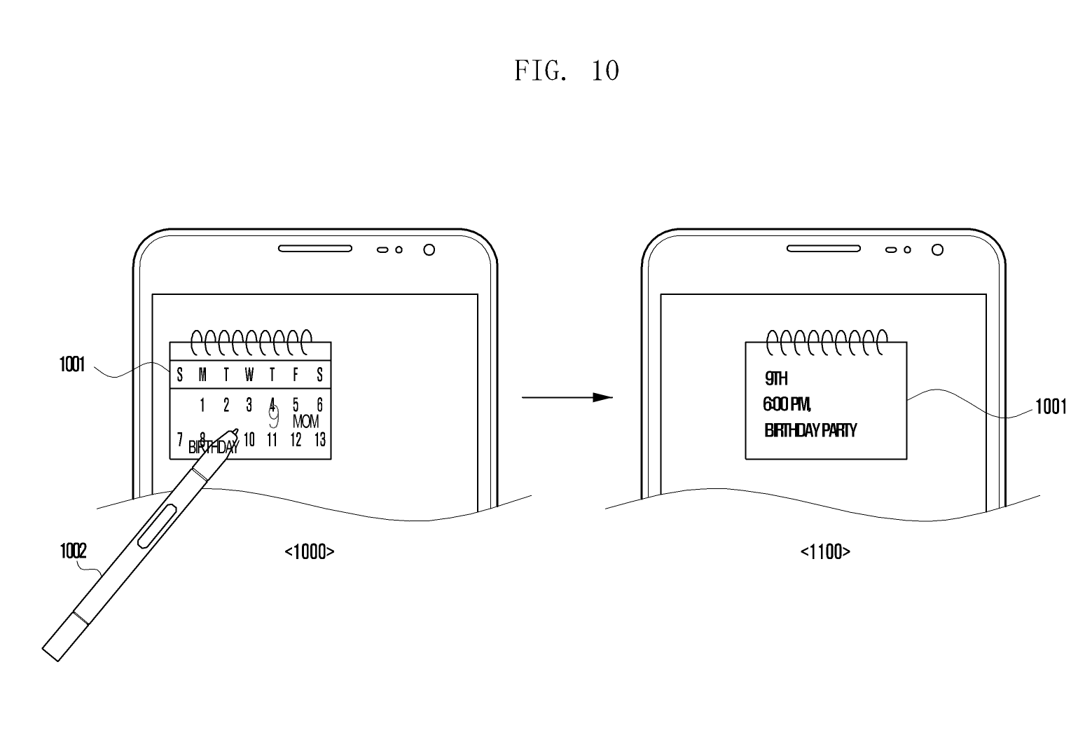

FIG. 10 is a diagram depicting an icon linked to schedule information, in accordance with aspects of the disclosure. Referring to FIG. 10, the control unit 160 may control the display unit 140 to display a scheduler application icon 1001 on an operation screen 1000. The scheduler application icon 1001 may depict of calendar. Schedule information (e.g., mom birthday) may be displayed at a designated day (e.g., the 9^{th}) in the calendar. If this schedule information is selected through a touch pen 1002 or user's finger, the control unit 160 may control the display unit 140 to display details (e.g., 9^{th} 6:00 pm, birthday party) about the selected schedule information. The information may be displayed in the scheduler application icon 1001 on an operation screen 1100.

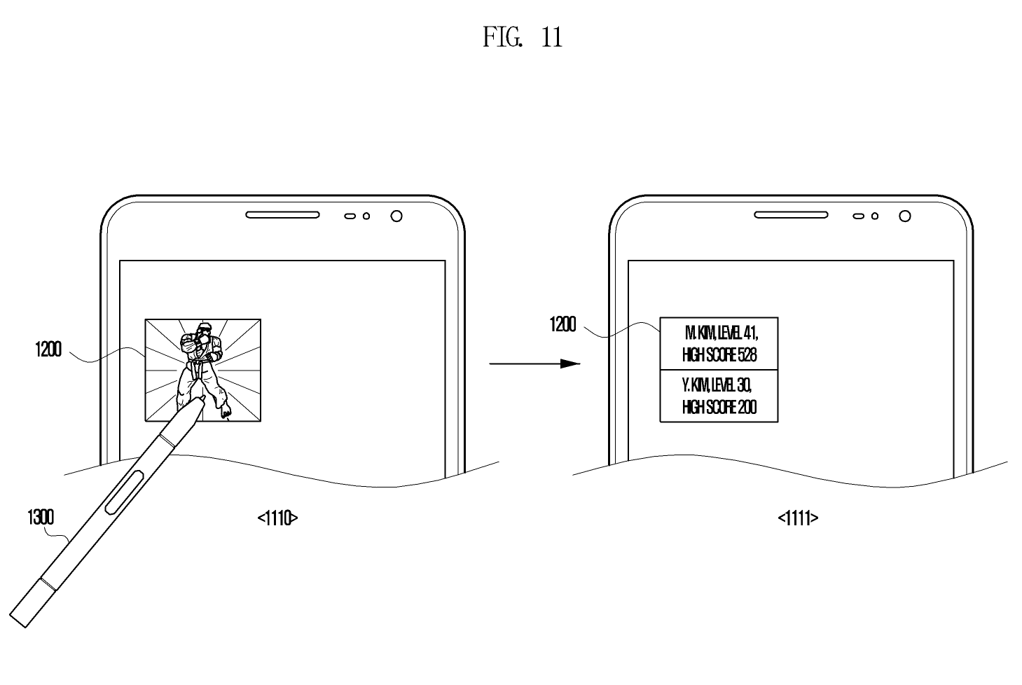

FIG. 11 is a diagram depicting an icon that has been linked to game information, in accordance with aspects of the disclosure. As illustrated, the control unit 160 may control the display unit 140 to display a game icon 1200 on an operation screen 1110. If the game icon is selected through a touch pen 1002 or user's finger, the control unit 160 may control the display unit 140 to display user's personal information (e.g., a game level and the highest score) in the game icon 1200.

As fully discussed hereinbefore, embodiments of the present disclosure may provide an advanced function control based on an icon in an electronic device. Additionally, the above-discussed methods and electronic device may detect a specific event occurring on or near the icon and, in response to the detected event, control an attribute of a particular function linked to the icon. This may provide a user interface allowing a simple and intuitive manipulation for a function control, thus eliminating unfavorable stepwise manipulations that are typically required for controlling function attributes. Further, the above-discussed method and electronic device may separately control the same or similar attribute of different functions on the basis of icons. Moreover, the above-discussed method and electronic device may display, in an icon, information about a recently controlled attribute of a function and/or information about contents recently created by a function.

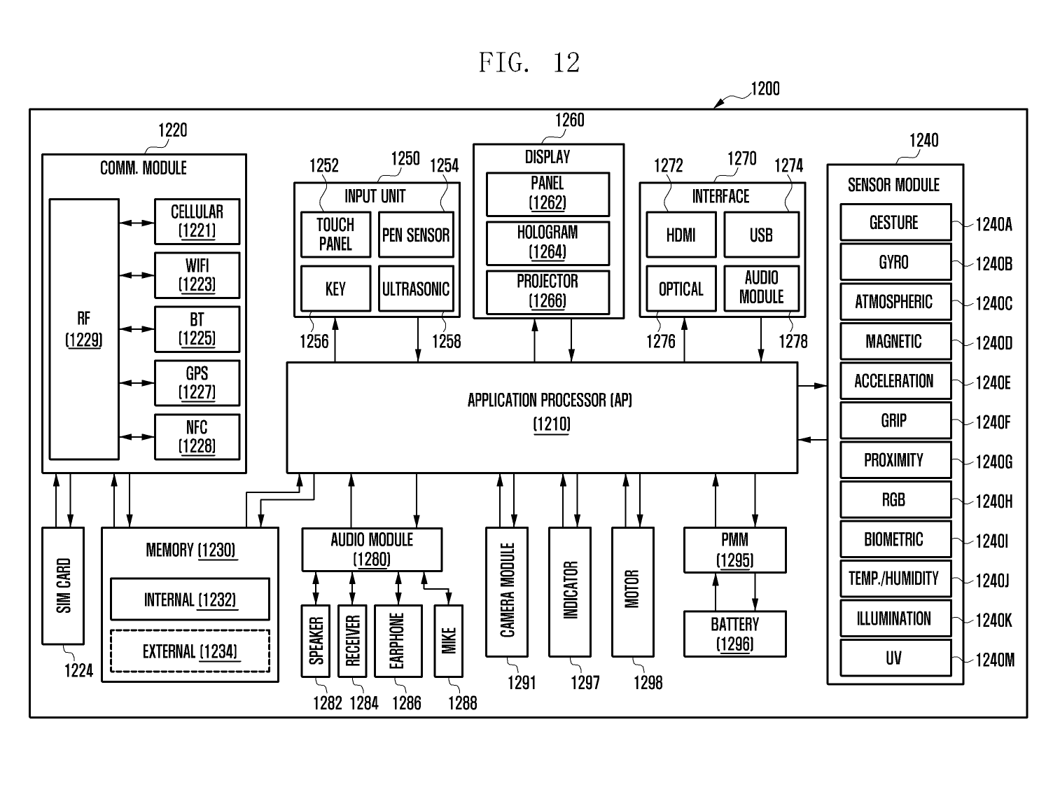

FIG. 12 is a block diagram of an electronic device, in accordance with aspects of the present disclosure. The electronic device 1200 of FIG. 12 may form a part or the whole of the electronic device 100 of FIG. 1. Referring to FIG. 12, the electronic device 1200 may include at least one application processor (AP) 1210, a communication module 1220, a subscriber identification module (SIM) card 1224, a memory 1230, a sensor module 1240, an input unit 1250, a display 1260, an interface 1270, an audio module 1280, a camera module 1291, a power management module 1295, a battery 1296, an indicator 1297, and a motor 1298.

The AP 1210 may drive an operating system or applications, control a plurality of hardware or software components connected thereto, and also perform processing and operation for various data including multimedia data. The AP 1210 may be formed of a system-on-chip (SoC), for example. In one aspect, the AP 1210 may further include a graphic processing unit (GPU) (not shown).

The communication module 1220 (e.g., the communication unit 110 in FIG. 1) may perform data communication between the device 1200 (e.g., the device 100 in FIG. 1) and any external entity (e.g., other electronic device or server) through a network. In one aspect, the communication module 1220 may include a cellular module 1221, a WiFi module 1223, a Bluetooth module 1225, a GPS (global positioning system) module 1227, an NFC (near field communication) module 1228, and an RF (radio frequency) module 1229.

The cellular module 1221 may offer a voice call, a video call, a message service, or an Internet access service through a communication network (e.g., LTE, LTE-A, CDMA, WCDMA, UMTS, WiBro, GSM, etc.). Using the SIM card 1224 for example, the cellular module 1221 may identify and authenticate the electronic device in the communication network. In one aspect, the cellular module 1221 may perform at least part of functions provided by the AP 1210. For example, the cellular module 1221 may perform, at least in part, a multimedia control function.

In one aspect, the cellular module 1221 may include a communication processor (CP). Additionally, the cellular module 1221 may be formed of SoC, for example. Although FIG. 12 shows the cellular module 1221, the memory unit 1230 and the power management module 1295 as separate components from the AP 1210, the AP 1210 may contain at least part of the above components (e.g., the cellular module 1221) in one aspect.

In one aspect, the AP 1210 or the cellular module 1221 (e.g., CP) may receive commands or data from at least one of a nonvolatile memory connected thereto and other components, and load the received commands or data into a volatile memory to process them. Also, the AP 1210 or the cellular module 1221 may store, in the nonvolatile memory, data received from or created by at least one of other components.

Each of the WiFi module 1223, the Bluetooth module 1225, the GPS module 1227 and the NFC module 1228 may include a processor for processing data received or transmitted through such a module. Although FIG. 12 shows the cellular module 1221, the WiFi module 1223, the Bluetooth module 1225, the GPS module 1227 and the NFC module 1228 as separate individual blocks, at least parts of them may be contained in a single IC (integrated circuit) or IC package. For example, at least parts of respective processors corresponding to the cellular module 1221, the WiFi module 1223, the Bluetooth module 1225, the GPS module 1227 and the NFC module 1228 (e.g., a CP of the cellular module 1221 and a WiFi processor of the WiFi module 1223) may be formed of a single SoC.

The RF module 1229 may transmit and receive data, e.g., RF signals. Although not shown, the RF module 1229 may include a transceiver, a PAM (power amp module), a frequency filter, an LNA (low noise amplifier), or the like. Also, the RF module 1229 may include any component, e.g., a wire or a conductor, for transmission of electromagnetic waves in a free air space. Although FIG. 12 shows that the cellular module 1221, the WiFi module 1223, the Bluetooth module 1225, the GPS module 1227 and the NFC module 1228 share the RF module 1229, at least one of them may use a separate RF module.

The SIM card 1224 contains a SIM therein and may be inserted into a slot formed at a certain place of the electronic device. The SIM card 1224 may include an ICCID (integrated circuit card identifier) or an IMSI (international mobile subscriber identity).

The memory 1230 (e.g., the memory unit 150 in FIG. 1) may include an internal memory 1232 and an external memory 1234. The internal memory 1232 may include, for example, at least one of a volatile memory (e.g., DRAM (dynamic RAM), SRAM (static RAM), SDRAM (synchronous DRAM), etc.) and a nonvolatile memory (e.g., OTPROM (one time programmable ROM), PROM (programmable ROM), EPROM (erasable and programmable ROM), EEPROM (electrically erasable and programmable ROM), mask ROM, flash ROM, NAND flash memory, NOR flash memory, etc.).

In one aspect, the internal memory 1232 may be an SSD (solid state drive). The external memory 1234 may include a flash drive, e.g., CF (compact flash), SD (secure digital), Micro-SD (micro secure digital), Mini-SD (mini secure digital), xD (extreme digital), memory stick, or the like. The external memory 1234 may be functionally connected to the electronic device 1200 via various interfaces. In one aspect, the electronic device 1200 may further include a storage unit (or a storage medium) such as a hard drive.

The sensor module 1240 may measure a certain physical quantity or detect an operating status of the electronic device 100, and then convert such measured or detected information into electrical signals. The sensor module 1240 may include, but not limited to, at least one of a gesture sensor 1240A, a gyro sensor 1240B, an atmospheric sensor 1240C, a magnetic sensor 1240D, an acceleration sensor 1240E, a grip sensor 1240F, a proximity sensor 1240G, a color sensor (e.g., an RGB (red, green, blue) sensor) 1240H, a biometric sensor 12401, a temperature-humidity sensor 1240J, an illumination sensor 1240K, and a UV (ultraviolet) sensor 1240M. Additionally or alternatively, the sensor module 1240 may include, for example, an E-nose sensor (not shown), an EMG (electromyography) sensor (not shown), an EEG (electroencephalogram) sensor (not shown), an ECG (electrocardiogram) sensor (not shown), an IR (infrared) sensor (not shown), an iris sensor (not shown), or a finger scan sensor (not shown). Also, the sensor module 1240 may include a control circuit for controlling one or more sensors equipped therein.

The input unit 1250 may include a touch panel 1252, a pen sensor 1254, a key 1256, or an ultrasonic input unit 1258. The touch panel 1252 may recognize a touch input in a manner of capacitive type, resistive type, infrared type, or ultrasonic type. Also, the touch panel 1252 may further include a control circuit. In case of a capacitive type, a physical contact or proximity may be recognized. The touch panel 1252 may further include a tactile layer. In this case, the touch panel 1252 may offer a tactile feedback to a user.

The pen sensor 1254 may be formed in the same or similar manner as receiving a touch input or by using a separate recognition sheet. The key 1256 may include a mechanical button, an optical key, or a keypad. The ultrasonic input unit 1258 is a specific device capable of identifying data by sensing sound waves with a microphone 1288 in the electronic device 1200 through an input tool that generates ultrasonic signals, thus allowing wireless recognition. In one aspect, using the communication module 1220, the electronic device 1200 may receive a user's input from any external device (e.g., a computer or server).

The display 1260 (e.g., the display unit 150 in FIG. 1) may include a panel 1262, a hologram unit 1264, or a projector 1266. The panel 1262 may be, for example, LCD (liquid crystal display) or AM-OLED (active matrix organic light emitting diode) or the like. The panel 1262 may have a flexible, transparent or wearable form. The panel 1262 may be formed of a single module with the touch panel 1252. The hologram unit 1264 may show a stereoscopic image in the air using interference of light. The projector 1266 may project light onto a certain screen and show an image thereon. This screen may be located inside or separated from the electronic device 1200. In one aspect, the display 1260 may further include a control circuit for controlling the panel 1262, the hologram unit 1264, or the projector 1266.

The interface 1270 may include a HDMI (high-definition multimedia interface) 1272, a USB (universal serial bus) 1274, an optical interface 1276, or a D-sub (D-subminiature). The interface 1270 may be, for example, included in the communication unit 110 shown in FIG. 1. Additionally or alternatively, the interface 1270 may include a MHL (mobile high-media card) interface, a SD (secure digital) card/MMC (multi-media card) interface, or an IrDA (infrared data association) interface.

The audio module 1280 may perform a conversion between sounds and electric signals. At least part of the audio module 1280 may be included, for example, in an input/output interface. The audio module 1280 may process sound information inputted or outputted through a speaker 1282, a receiver 1284, an earphone 1286, or a microphone 1288.

The camera module 1291 is a device capable of obtaining still images or moving images. In one aspect, the camera module 1291 may include at least one image sensor (e.g., a front sensor or a rear sensor), a lens (not shown), an ISP (image signal processor, not shown), or a flash (not shown, e.g., LED or a xenon lamp).

The power management module 1295 may manage electric power of the electronic device 1200. Although not shown, the power management module 1295 may include a PMIC (power management integrated circuit), a charger IC, a battery, or a fuel gauge.

The PMIC may be formed of an IC chip or SoC. Charging may be performed in a wired or wireless manner. The charger IC may charge a battery and prevent overvoltage or overcurrent form a charger. In one aspect, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of battery 1296 and a voltage, current or temperature in a charging process. The battery 1296 may store or create electric power therein and supply electric power to the electronic device 1200. The battery 1296 may include, for example, a rechargeable battery or a solar battery.

The indicator 1297 may show a current status (e.g., a booting status, a message status, or a recharging status) of the electronic device 1200 or of its part (e.g., the AP 1210). The motor 1298 may convert an electric signal into a mechanical vibration. Although not shown, the electronic device 1200 may include a specific processor (e.g., GPU) for supporting a mobile TV. This processor may process media data that comply with standards of DMB (digital multimedia broadcasting), DVB (digital video broadcasting), or media flow.

The above-discussed method is described herein with reference to flowchart illustrations of user interfaces, methods, and computer program products according to aspects of the present disclosure. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While this disclosure has been particularly shown and described with reference to an exemplary aspect thereof, it will be understood by those skilled in the art that various changes in form and details may be made therein without departing from the spirit and scope of this disclosure as defined by the appended claims.

What is claimed is:

1. A method for presenting an icon, the method comprising:
displaying a notification associated with the icon;
changing, by a processor, an attribute of the function from a first value to a second value based on an input received via the notification;
modifying the notification to indicate the second value of the attribute; and
displaying the modified notification together with the icon.

2. The method of claim 1, wherein modifying the notification includes at least one of adding a visual effect to the notification or changing a characteristic of an appearance of the notification.

3. The method of claim 1, wherein the notification is displayed within the icon or adjacent to the icon or a portion of the notification is displayed as overlapping with the icon.

4. The method of claim 1, further comprising executing the function based on the second value of the attribute.

5. The method of claim 4, further comprising:
generating a content item as a result of executing the function; and
displaying, together with the icon, another notification associated with the generated content item.

6. The method of claim 5, wherein displaying the another notification comprises one of:
displaying the another notification within the icon;.
displaying the another notification adjacent to the icon; and
displaying a portion of the another notification as overlapping with the icon.

7. The method of claim 5, wherein the content item is generated as a result of a last execution of the function.

8. The method of claim 1, wherein the notification includes a list of content items created as a result of executing the function.

9. The method of claim 1, wherein the attribute specifies at least one of a sound volume level for sounds produced by the function and a time at which the function is to perform an operation.

10. The method of claim 9, wherein:
the notification includes a visual representation of a speaker when the attribute specifies the sound volume; and
the notification includes a visual representation of a clock when the attribute specifies the time at which the function is to perform the operation.

11. A method for presenting an icon, the method comprising:
displaying a first notification associated with the icon;
in response to a first input to the first notification, displaying a second notification; and
in response to a second input to the second notification, changing, by a processor, an attribute of the function from a first value to a second value;
wherein the attribute of the function is changed while the function is not being executed by the processor.

12. The method of claim 11, further comprising executing the function based on the second value of the attribute.

13. An electronic device comprising:
a display panel configured to display an icon for executing a function and a notification associated with the icon;
a touch panel configured to receive touch input; and
a control unit configured to change an attribute of the function from a first value to a second value in response to a touch performed on the notification, to modify the notification to indicate the second value of the attribute, and to control the display panel to display the modified notification together with the icon.

14. The electronic device of claim 13, wherein modifying the notification includes at least one of adding a visual effect to the notification or changing an appearance of the notification.

15. The electronic device of claim 13, wherein the control unit is further configured to execute the function based on the second value of the attribute.

16. The electronic device of claim 15, wherein the control unit is further configured to generate a content item by executing the function and control the display panel to display, together with the icon, another notification associated with the generated content item.

17. The electronic device of claim 16, wherein displaying the another notification includes one of:
displaying the another notification within the icon;
displaying the another notification adjacent to the icon; and
displaying a portion of the another notification as overlapping with the icon.

18. The electronic device of claim 16, wherein the content item is generated as a result of a last execution of the function.

19. The electronic device of claim 16, wherein the notification includes a list of content items created as a result of executing the function.

20. The electronic device of claim 13, wherein the attribute specifies at least one of a sound volume level for sounds produced by the function and a time at which the function is to perform an operation.
